(19) United States
(12) Patent Application Publication
(10) Pub. No.: US 2025/0156537 A1
(43) Pub. Date: May 15, 2025

(54) DOCUMENT OPEN DETECTION AND REMEDIATION

(71) Applicant: Proofpoint, Inc., Sunnyvale, CA (US)

(72) Inventors: Nir Barak, Karmei Yosef (IL); Boris Traktimik, Ashdod (IL); Itay Sofer, Modíin (IL); Gabriel Kalmar, Raanana (IL)

(21) Appl. No.: 18/840,131

(22) PCT Filed: Feb. 22, 2023
(86) PCT No.: PCT/US2023/062987

§ 371 Date: Aug. 21, 2024

Related U.S. Application Data
(60) Provisional application No. 63/314,192, filed on Feb. 25, 2022.

(51) Int. Cl. G06F 21/55; G06F 11/34; G06F 16/17; G06F 21/62

(52) U.S. Cl. CPC G06F 21/554; G06F 11/3438; G06F 16/1734; G06F 21/6209

(57) ABSTRACT

A computer system detects whether a new document has been opened at a user computer on the computer system. The system includes a user computer, a user application accessible by a human user at the user computer, and an agent application hosted by the user computer. The agent is configured to register to receive notifications of user interface actions with an operating system (OS) of the user computer. The agent receives a notification from the OS of a user interface action, and determines whether a new document was opened at a display screen of the user computer by the user interface action.

### CROSS-REFERENCE TO RELATED APPLICATIONS

This application claims the benefit of U.S. Provisional Patent Application Ser. No. 63/314,192, filed Feb. 25, 2022, entitled “DOCUMENT OPEN DETECTION AND REMEDIATION,” which is incorporated by reference herein in its entirety.

### FIELD OF THE INVENTION

The present invention relates to computer system security, and more particularly, is related to document open detection and remediation.

### BACKGROUND OF THE INVENTION

Enterprise computer systems administrators manage information accessible via the computer system by employees and/or contractors of the organization. The system administrators look to protect against data loss and brand damage involving insiders with computer system access acting maliciously, negligently, and/or unknowingly. Therefore, there is a need in the industry for system administrators to determine whether a document being opened by a user of the computer system may represent a security threat.

### SUMMARY OF THE INVENTION

Embodiments of the present invention provide document open detection and remediation. Briefly described, the present invention is directed to a computer system configured to detect whether a new document has been opened at a user computer on the computer system. The system includes a user computer, a user application accessible by a human user at the user computer, and an agent application hosted by the user computer. The agent is configured to register to receive notifications of user interface actions with an operating system (OS) of the user computer. The agent receives a notification from the OS of a user interface action, and determines whether a new document was opened at a display screen of the user computer by the user interface action.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic block diagram of an exemplary computer network of a first system embodiment.

FIG. 2 is a schematic block diagram detailing of an exemplary endpoint device of FIG. 1.

FIG. 3 is a schematic system block diagram detailing an implementation of the relationship between the ITM Application Server and an exemplary endpoint device of FIG. 1.

FIG. 4 is a flowchart of an exemplary process embodiment that may be performed with the system of FIG. 3.

FIG. 5 shows an exemplary screenshot of document open reports generated by system of FIG. 3.

FIG. 6 is a schematic block diagram detailing an exemplary implementation of the process of FIG. 4.

FIG. 7A is a flowchart of an exemplary method embodiment for an agent application hosted by a user computer of a computer system for detecting whether a new document has been opened via a user application accessible by a human user at the user computer at the user computer.

FIG. 7B is flow chart detailing block 730 of FIG. 7A.

FIG. 8 is a schematic diagram illustrating an example of a system for executing functionality of the present invention.

### DETAILED DESCRIPTION

The following definitions are useful for interpreting terms applied to features of the embodiments disclosed herein, and are meant only to define elements within the disclosure.

This document uses a variety of terminology to describe the inventive concepts set forth herein. Unless otherwise indicated, the following terminology, and variations thereof, should be understood as having their ordinary meanings and/or meanings that are consistent with what follows.

A “computer file” (or “file”) is a computer resource for recording data in a computer storage device and primarily identified by its file name. Different types of computer files are designed for different purposes. A document file, for example, may be designed to store a document (e.g., a written message, a spreadsheet, an image, etc.), whereas other types of files may be designed to store computer programs, for example.

The word “document” refers to the content contained in certain types of computer files (i.e., “document files”) that associated computer programs (e.g., Microsoft Word, Excel, PowerPoint, Adobe Acrobat, Foxit Reader, etc.) can display to a human user on a computer display screen. Although the content in a document file is arranged in a format that the associated computer program can interpret, human users typically are able to choose the name and storage location of the document file and provide most (if not all) of the information (such as words and/or text and/or images) to be stored in the document file. A window can contain documents or non-documents. Non-documents might include, for example, a listings of files (e.g., in a file manager interface), a listing of computer program files, and certain types of interfaces, such as web browsers, etc.

A “window” is a graphical control element on a computer's display screen. A window typically has a visual area containing at least some of the graphical user interface of the program to which it belongs and is framed by window decoration. A window is usually rectangular and can overlap with the area of one or more other windows on the display screen. A window may display the output of one or more computer processes and may allow a human user, for example, to enter data into the one or more computer processes. A window typically has a border that creates a visual separation between the window's contents and the rest of a desktop environment. The border may include a title bar that is usually along the top of the window. The title bar may include information about that window and may include user-selectable buttons such as: close, maximize, and minimize. The information about the window may include, for example, an identification of the computer application (e.g., File Explorer, Microsoft Word, Adobe Acrobat, Autodesk AutoCAD, Google Chrome, etc.) associated with that window. Moreover, in some implementations (e.g., when the window contains a visual representation of a document), the title information included in the title bar of the window may include a file name for the document visible in the window. Moreover, in some instances, the window belongs to an app (application), where the app is part of a user session, and the session includes information including the username the session belongs to. A window may contain a visual representation of a document (e.g., the contents of a stored file). For example, some windows contain a visual representation of a Microsoft® Word™ document, or a Microsoft® Excel™ spreadsheet, or a document in portable document format (pdf), or a document in rich text format (RTF), etc. Not all windows, however, contain a visual representation of a document. Some windows contain listings of files (e.g., File Explorer) or other non-document data.

As used within this disclosure, an “in-focus window” or “focus window” refers to a window the user is currently interacting with. For example, if there are several windows open in a display, the in-focus window is typically the active window the user is working with, often displayed topmost. Typically, the operating system may graphically indicates the in-focus window, for example, by differences in coloring and/or shading of the in-focus window in contrast to the other windows.

The phrase “user session” or “session” refers to a temporary and interactive information interchange between two or more communicating devices, or between a computer or network resources and a human user. A session is generally established at a certain point in time, and then ended at some later point in time. One particular type of user session is a “login session,” which refers to the period of time and activity between a human user logging in and logging out of a (typically multi-user) system.

As used within this disclosure, the phrase, “document was opened at a display screen of the user computer” indicates that an opened document was displayed at the computer display screen, for example, in a window, such that the user of the computer was able to view the content (for example, text and/or images) contained in the document.

This application discloses systems and techniques for detecting a document open action on a computer of a computer network, by inspecting a current window in focus for the document it holds, using methods that involve the operating system of the computer (and an agent deployed on the computer), and detecting when a new document is opened by comparing an older document (from the current window), with the current document being held by the current window.

In an exemplary embodiment, detecting a document open event is done on the user interface (UI) level. The embodiment differentiates between a user actively opening and viewing a document from an application process accessing the document. The application holds a cache of the documents opened by each window in the user session, every click in the current window in focus causes the system to consider the document held by this window and compare it to the document stored in cache. If the current document is different than the stored document, then the system concludes that a new document has been opened. Detection now scans and sends an event and updates the cache, taking into account information stored in association with the document's history.

In an exemplary implementation, the solution may be based on several steps:
(1) Detecting a click in the current window in focus and computing a current document held by the app inside this window, this may be exposed by a window system, either through accessibility or by a title of the window, and can be correlated with open files by that process;
(2) Comparing the current document for the window with the current document of the window information in the application cache;
(3) if the document is different, scanning the file and creating a document open event, including, for example, information on the user, process, and file, and sending it all to a remote server and updating the cache;
(4) Triggering user notifications (and/or admin notifications) in case of opening a sensitive document, if the rules are setup for this; and
(5) Sending the event information to the server for incident exploration.

The systems and techniques disclosed herein can be advantageously deployed in a variety of different computer-based environments. In one exemplary implementation, the systems and techniques may be deployed in connection with and as a part of a computer-based Insider Threat Management (ITM) solution. One example of a computer-based ITM solution, in which the systems and techniques disclosed herein may be deployed is the ITM solution available from Proofpoint, Inc., an applicant on this application. At a high level, Proofpoint's ITM protects against data loss and brand damage involving insiders acting maliciously, negligently, and/or unknowingly. Proofpoint's ITM correlates user activity and data movement to empower security teams to identify user risk, detect insider-led breaches, and accelerate security incident responses.

In various implementations, the systems and techniques described by the exemplary embodiments herein can enhance the security afforded by a system like Proofpoint's ITM to provide security teams with a deeper understanding of user behavior and associated risk across a monitored computer network. Additionally, in various implementations, the systems and techniques disclosed herein may be utilized to quickly identify and, in some instances, automatically remediate the unauthorized opening of documents that may contain, for example, confidential or otherwise sensitive company data. Moreover, in a typical implementation, the systems and techniques disclosed herein detect the opening of certain files at endpoint devices across the monitored computer network. Further, in a typical implementation, the systems and techniques disclosed herein may track and/or generate reports on any file openings that occur at the endpoint devices for document files only, and only if the document file was in-focus at the endpoint device, such that the underlying document was likely to have been actually seen by the human user on the display screen of the corresponding endpoint device. The embodiments allow these functionalities to be performed in a highly efficient and nonintrusive manner.

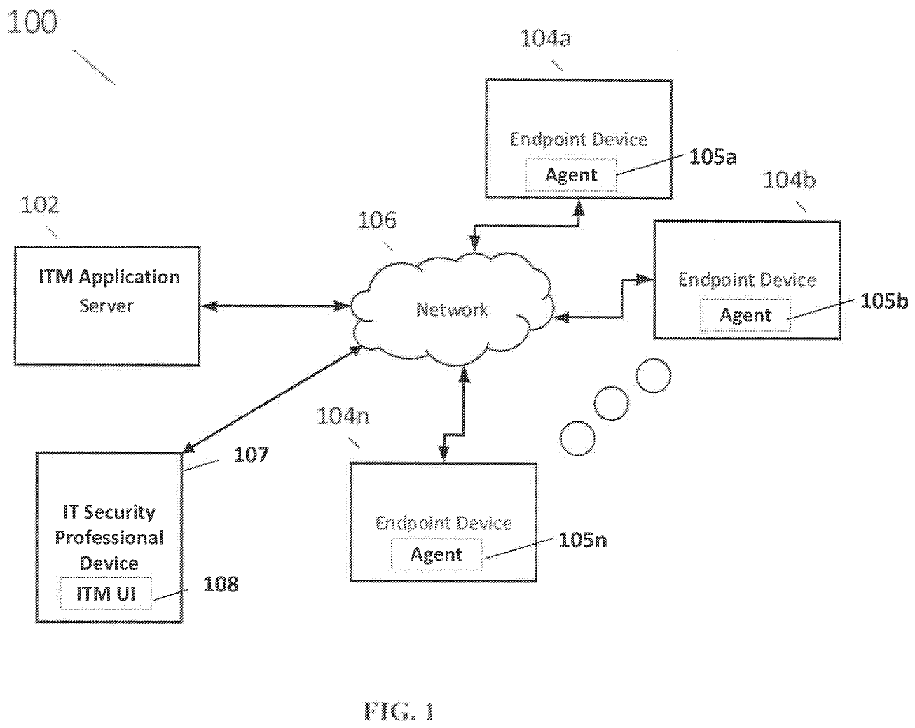

FIG. 1 is a schematic block diagram of an exemplary computer network 100 that has an ITM application server 102, a plurality of user endpoint devices 104a, 104b, 104n, and a device 107 (e.g., a laptop or desktop computer, a tablet computer, a mobile smart device, etc.) for an IT security professional coupled to one another via a communications network 106 that enables the server 102, the endpoint devices 104a, 104b . . . 104n, and device 107 to communicate with one another.

Each endpoint devices 104a, 104b . . . 104n may be virtually any type of computer hardware device, with software running thereupon, that a company employee might use, for example, to perform work for or on behalf of his or her employer. Examples of endpoint devices include desktop computers, laptop computers, mobile smart devices, including smartphones, touchscreen devices, such as tablets, workstations, among others.

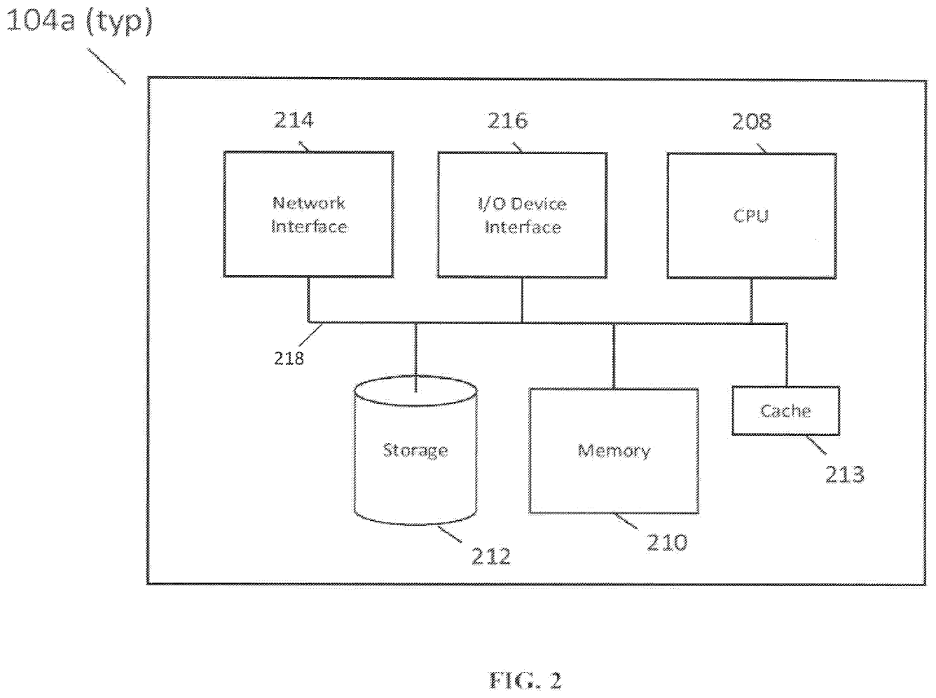

FIG. 2 shows a schematic representation of an example of an endpoint device 104a, 104b . . . 104n.

The illustrated endpoint device (here 104a) includes a processor 208, endpoint device-based memory 210 (for example, random access memory (RAM)), endpoint device-based storage 212 (for example, a hard drive or solid state drive, amongst others), a network interface 214, an input/output device interface 216, a cache memory 213, and a bus 218 that serves as an interconnect between the components of the endpoint device 104a. The bus 218 acts as a communication medium over which the various components of the endpoint device 104a can communicate and interact with one another.

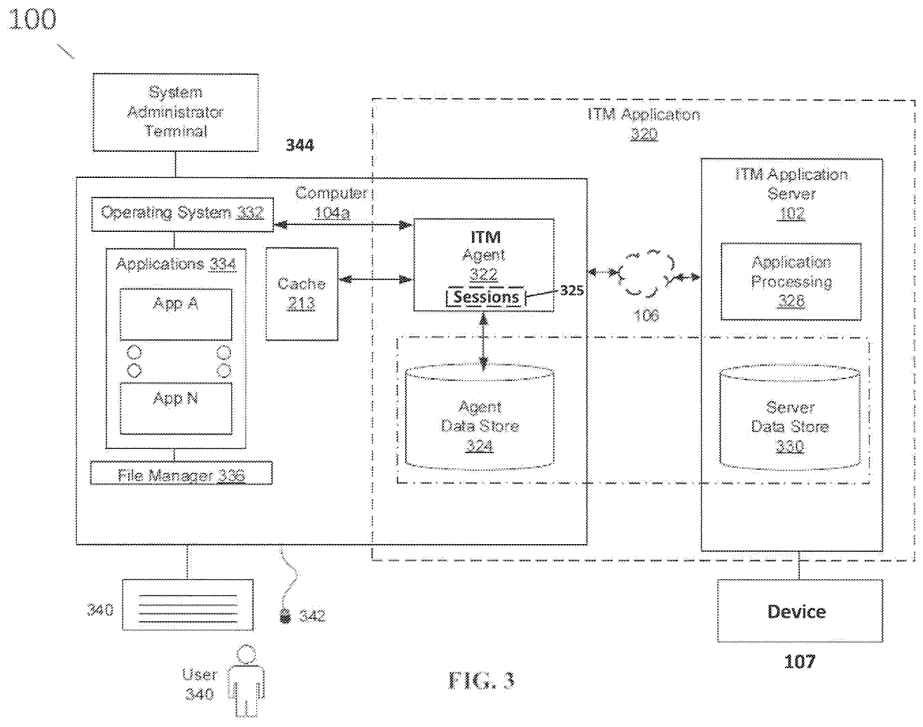

The processor 208 is configured to perform the various endpoint device-based functionalities disclosed herein as well as other supporting functionalities not explicitly disclosed herein. In certain implementations, some of the endpoint device-based functionalities that the processor 208 performs include are those functionalities disclosed herein as being attributable to any one or more of components shown in FIG. 3 and more. Typically, the processor 208 performs these and other functionalities by executing instructions readable by endpoint device 104a stored on an endpoint device-readable medium, for example memory 210 and/or storage 212. In various implementations, some of the processor functionalities may be performed with reference to data stored in one or more of these endpoint device-readable media 210, 212 and/or received from some external source, for example, from an I/O device through the I/O device interface 216 and/or from an external network via the network interface 214. The processor 208 in the implementation shown in FIG. 3 is represented as a single hardware component at a single node. In alternative implementations, however, the processor 208 may be distributed across multiple hardware components at different physical and network locations. In general, the endpoint device 104a may have both volatile and non-volatile memory/storage capabilities.

In the implementation shown in FIG. 3 memory 210 provides volatile storage capability for endpoint device-readable instructions that, when executed by the processor 208, cause the processor 208 to perform at least some of (or all) the endpoint device-based functionalities disclosed herein. More specifically, in a typical implementation, memory 210 stores one or more computer software programs that enable a human user 340 to perform functionalities (e.g., access, review, edit, and save documents) as required for his or her role in the company. As shown by FIG. 3, memory 210 is represented as a single hardware component at a single node in one single endpoint device 104a. However, in various implementations, memory 210 may be distributed across multiple hardware components at different physical and network locations, for example, in different endpoint devices.

Storage 212 may provide non-volatile memory for endpoint device-readable instructions representing an operating system, configuration information, among others, to support the systems and endpoint device-based functionalities disclosed herein. Here, storage 212 is represented as a single hardware component at a single node in one single endpoint device 104a. However, in alternative implementations, storage 212 may be distributed across multiple hardware components at different physical and network locations (e.g., in different endpoint devices).

The network interface 214 enables the endpoint device 104a to connect to, and communicate over, any one of a variety of different external endpoint device-based communications networks, including, for example, local area networks (LANs), wide area networks (WANs) such as the Internet, etc. The network interface 214 may be implemented in hardware, software, or a combination of hardware and software.

The input/output (I/O) device interface 216 enables the endpoint device 104a to interface with any one or more input or output devices, such as a keyboard, mouse, display, microphone, speakers, printers, image scanners, digital cameras, among others. Depending upon the desired implementation, the I/O device interface may be implemented in hardware, software, or a combination of hardware and software. In a typical implementation, the endpoint device may include one or more I/O devices, for example, a endpoint device screen, keyboard, mouse, printer, touch screen device, image scanner, digital camera, among others, interacting with the endpoint device 104a via the device interface 216. These I/O devices (not shown in FIG. 2) may act as human-machine-interfaces (HMIs) and are generally configured to enable a human user to interact with the system 104a to access and utilize the functionalities disclosed herein.

In an exemplary implementation, the endpoint device 104a is connected to a display device, for example, via the I/O device interface 216, and configured to present at the display device a visual representation of an interface to an environment that may provide access to at least some of the functionalities disclosed here. The cache memory is a 213 is a type of computer memory that acts as a buffer, for example, a region of physical memory storage used to temporarily store data.

In some implementations, the endpoint device 104a and its various components may be contained in a single housing, for example, a personal laptop computer, or at a single workstation. In some implementations, the endpoint device 104a and its various components may be distributed across multiple housings, perhaps in multiple locations on a network. Each component of the endpoint device 104a may include multiple versions of that component, possibly working in concert, and those multiple versions may be in different physical locations and connected via a network. For example, the processor 208 in FIG. 3 may be formed from multiple discrete processors in different physical locations working together to perform processes attributable to the processor 208 as described herein, in a coordinated manner. A wide variety of possibilities regarding specific physical configurations are possible.

In various implementations, the endpoint device 104a may have additional elements not shown in FIG. 2. These can include, for example, controllers, buffers (caches), drivers, repeaters, receivers, etc. The interfaces (e.g., 214, 216) in particular may include elements not specifically represented in FIG. 2, including, for example, address, control, and/or data connections to facilitate communications between the illustrated endpoint device components.

In a typical implementation, each of the other endpoint devices 104b . . . 104n. the admin device 108, and/or the ITM application server 102 may have the same (or a substantially similar) component layout and configuration as the endpoint device 104a represented in FIG. 2. For example, each of these other network components typically has a computer processor, computer-readable media (e.g., memory, storage), a network interface (to facilitate communications over network 106), and (optionally) an I/O device to facilitate user interactions with that network component, via a connected I/O device.

Referring again to the computer network 100 of FIG. 1, there may be an agent 105a, 105b . . . 105n deployed at each respective one of the endpoint devices 104a, 104b . . . 104n. At a high level, in a typical implementation, the agents 105a, 105b . . . 105n collect user activity data at their respective endpoint devices 104a, 104b . . . 104n, perform light processing on that collected data, and transmit data and/or related communications, for example over the network 106, to the ITM application server 102 for further processing and/or event reporting, for example, to a human information technology (IT) security professional at device 107, if warranted. In some implementations, the systems and functionalities disclosed herein may be implemented as a cloud solution. In such instances, the ITM application server 102 may instead be a cloud service where the agents communicate and interact with the cloud service in a similar manner.

The agents 105a, 105b . . . 105n may be configured and deployed on the endpoint devices 104a, 104b . . . 104n in a variety of possible ways. In a typical implementation, however, each agent 105a, 105b . . . 105n is implemented by a processor 208 in the corresponding endpoint device 104a, 104b . . . 104n executing computer-readable instructions stored on a computer-readable media (e.g., 210, 212) operatively coupled to the processor 208, that, when executed by the processor 208, cause the endpoint device 104a, 104b . . . 104n to perform functionalities associated with an agent 105a, 105b . . . 105n, as described herein.

In a typical implementation, the ITM application server 102 in the illustrated network 100 includes a processor that executes computer-readable instructions stored on computer-readable media operatively coupled to the processor that causes the ITM application server 102 to perform functionalities described herein as attributable to the ITM application server 102.

Device 107 has a computer display that displays a user interface (UI) that enables IT security professionals, for example, to view and/or interact with ITM-related data, functionalities, event reports, etc.

FIG. 3 is a partial schematic representation of computer network 100 with an exemplary implementation of an insider threat management (ITM) application 320 that includes an embodiment of the document open detection technology disclosed herein. The ITM application 320 may be deployed in a number of possible ways. However, in a typical implementation, the ITM application is deployed as software stored on computer-readable media with computer hardware including one or more computer processors performing functionalities associated with the ITM application 320 software as disclosed herein. More specifically, the ITM application 320 in the illustrated implementation is distributed across a portion of the computer network 100 that includes the user endpoint device 104a (which, in the illustrated implementation, is a computer), and the ITM application server 102, which are configured to communicate with one another over the communications network 106.

The ITM application 320, as deployed, includes an ITM agent 322 and an agent data store 324 (collectively agent 105a in FIG. 1) that reside at the endpoint device 104a. For purposes of brevity, references to the agent 322 herein generally refer to the combination of the agent 322 and the agent data store 324. The ITM application 320, as depicted, also includes an ITM application processor 328, and an ITM application data store 330 deployed at the ITM application server 102.

The ITM agent 322 at the endpoint device 104a may be implemented by a computer processor 208 in the endpoint device 104a executing software stored in computer-based memory 210 in the endpoint device 104a. The agent data store 324 may be implemented, for example, within a portion of computer-based memory 210, 212 in the endpoint device 104a. The application processor 328 in the ITM application server 102 may be implemented by a computer processor at the ITM application server 102 executing software stored in computer-based memory in the ITM application server 102. The server data store 330 may be implemented, for example, within a portion of the computer-based memory at the ITM application server 102. Collectively, the agent data store 324, the server data store 330, and cache 213 provide storage to support functionalities associated with the ITM application 320.

In some implementations, the agent 322 includes a user sessions monitor 325 to collect, track, and/or manage various aspects of user session data for user sessions (for example, login sessions) at the endpoint device 104a. The user sessions monitor 325 may be implemented in the form of software stored in memory 210, 212 that can be executed by a computer processor 208 to perform functionalities associated with the user sessions monitor 325, as described herein.

The endpoint device 104a in the illustrated implementation also has an operating system 332, a plurality of software applications 334 (App A . . . App N), a file manager 336, and the cache memory 213. In a typical implementation, each of these components may be implemented by a computer processor 208 executing software stored in computer-based memory (210, 212) in the endpoint device 104a. In the embodiment shown by FIG. 3, the operating system 322 is configured to manage various hardware and software operations within the endpoint device 104a. Examples of operating systems include the Windows® operating system from Microsoft Corporation, the macOS™ operating system from Apple, Inc., and variations of the Linux operating system. In a typical implementation, the applications 334 (App A . . . App N) are configured to perform various functionalities accessible to a human user 340 at the endpoint device 104a. Examples of applications 334 include software programs for word processing, spreadsheets, accounting, web browsers, email applications, media players, file viewers, simulators, console games, photo editors, among others.

In a typical implementation, the file manager 336 is configured to manage and organize files within memory of the endpoint device 104a. Some of the more common operations that may be performed by a file manager on a file, or on a group of files include creating, opening (e.g., displaying, playing, etc.), renaming, copying, moving, deleting, and searching, as well as modifying file attributes, properties, and permissions. Typically, the cache memory 213 is a kind of computer memory with very short access time and is appropriate for use as a temporary storage location for frequent accessing data stored within, for example documents and/or document data, by the agent 322 and/or others.

The operating system 332 in the illustrated implementation is coupled to and able to communicate with various components including the applications 334 and the file manager 336, and is able to receive information about user activities at the endpoint device 104a, for example, from each of these components. The operating system 332 is also coupled to and able to communicate with the agent 322. In an exemplary implementation, the agent 322 can establish the coupling with the operating system 332 by registering to receive notifications from the operating system 332 anytime a user activity (for example, a click of the mouse 342, a click on the keyboard 340, etc.) is detected by the operating system 332. Subsequently, whenever a user activity occurs at the endpoint device 104a, the operating system 332 is able to provide a notification that may include underlying data/metadata about the user activity to the agent 322. The underlying data may include, for example, various pieces of data/metadata associated with the user activity as disclosed herein, one or more screenshots associated with the user activity, and/or other data or metadata. This data/metadata can originate at the operating system 332, at any one or more of the applications 334, at the file manager 336, and/or from any one or more other data sources within the user endpoint device 104a. More specifically, in a typical implementation the windows information comes from the windows management system (UI) of the OS. Some of the user activity data that the agent 322 receives in this regard may be relevant to enabling the agent to determine whether or not the in-focus window on the endpoint device 104a at the time of the user activity contained a document, and whether or not the latest user activity caused or resulted in that document being newly opened in the window. In a typical implementation, the agent 322 processes the user activity data the agent 322 receives to make the aforementioned (and potentially other) determinations about the user activity.

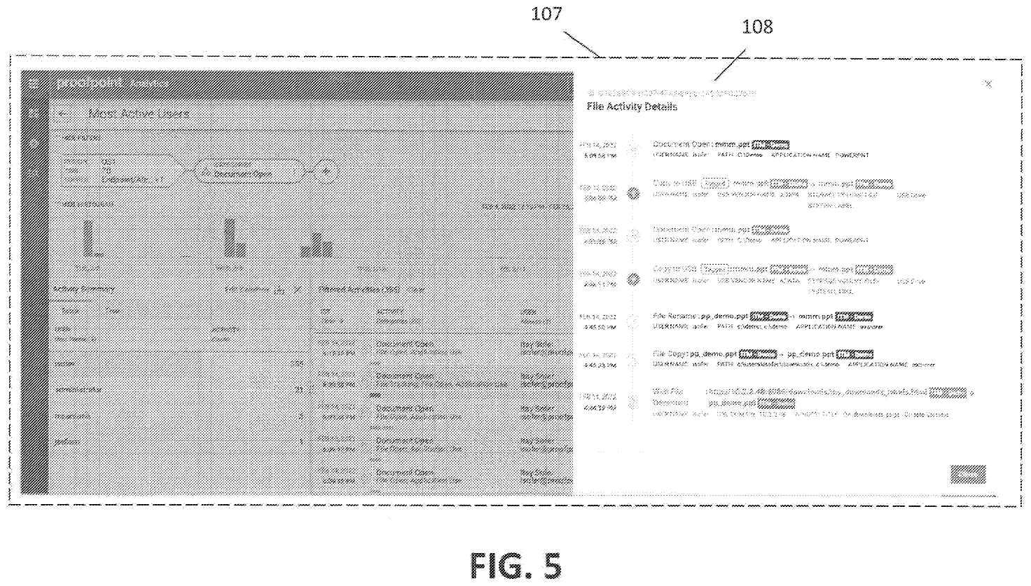

The illustrated network 100 generally also includes a device 107 (e.g., a laptop or desktop computer, a tablet computer, a mobile smart device, etc.) for an IT security professional. In general, the IT security professional is a human responsible for administering and/or monitoring aspects of the computer network (including endpoint device 104a) related to security. In a typical implementation, the system 100 is configured to produce network security reports for the IT security professional to review and/or act upon, as appropriate or desired. An exemplary excerpt of a network security report is shown in FIG. 5.

To be clear, the user 340 is a human who interacts with the computer 104a (e.g., using the applications 334, etc.), and the IT security professional is also a human who monitors, controls, and/or interacts with the system 100 and ITM application 320 via device 107. Of course, there may be a plurality of users 340, IT security professionals, and/or general system administrators (that access the system 100 through computer terminal 344), etc. In some circumstances, the IT security professional(s) and the system administrators may include the same individual(s).

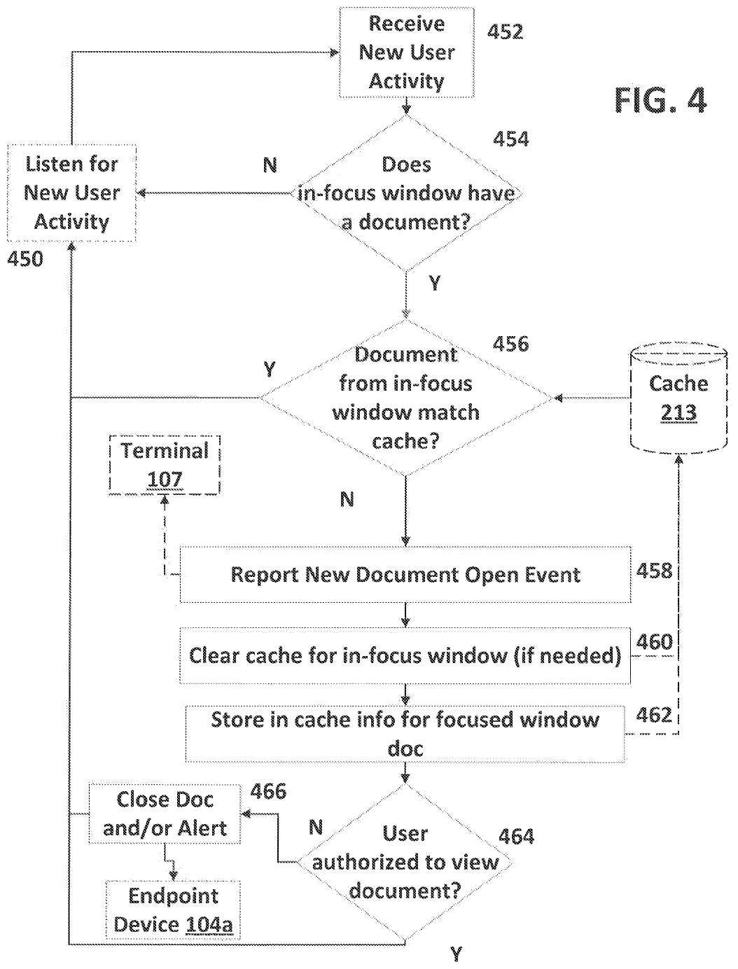

FIG. 4 is a flowchart of an exemplary method embodiment that may be performed on system 100 of FIG. 3, for example, to detect when a new document has been opened at endpoint device 104a, and to generate reports based upon on any such detected new document open event.

The agent 322 (at 450) listens for a user activity at the endpoint device 104a, for example, a mouse-click, a press of a keyboard button, and a touch of a touch sensitive object on a touch screen, among others. Upon occurrence of user activity, the agent 322 receives a notification indicating the user activity has occurred at the associated endpoint device 104a, as shown by block 452. In an exemplary implementation, the agent 322 receives the notification from the operating system 332 of the associated endpoint device 104a.

In various implementations, the agent 322 may receive a variety of other data (including, potentially, metadata) related to the underlying user activity along with, or at least in logical association with, the user activity notification that the agent 322 receives. The data typically includes data that is relevant to whether the content of the focused window is a document or not. Moreover, the data may include a copy of the document itself and/or various pieces of information that identify one or more identifying characteristics of the document itself, such as title, file name, associated application, document identifier, etc.

The user activity notification data may include one or more screenshots from the endpoint device 104a where the underlying user activity occurred. If any screenshots (or other data or metadata) are provided to the agent 322, they may be captured from the endpoint device 104a at the time of (and/or shortly thereafter) the time of the underlying user activity. Various other types of data or metadata about the underlying user activity, some of which may be disclosed herein, may be received with or in association with a user activity notification, as desired.

As shown by block 454, in response to the user activity notification, the agent 322 determines whether or not the in-focus window on the display screen of the corresponding endpoint device 104a was displaying a document concurrently with the underlying user activity. There are a variety of ways in which the agent 322 might make this determination. some of which are disclosed in further detail herein.

If the agent 322 determines the window in-focus at the time of the user activity was not displaying a document, then the system 100 may perform other functionalities based on the user activity notification or may revert back to waiting and listening for the next new user activity as shown by block 450.

If the agent 322 concludes that the window in-focus at the time of the user activity was displaying a document, then the agent 322 determines whether the document from the in-focus window matches whatever document is stored in cache 213 in association with the in-focus window, as shown by block 456. There are a variety of ways in which the agent 322 might make this determination, some of which are disclosed in further detail herein. In a typical implementation, the agent 322 compares the document from the in-focus window to the document stored in the cache 213.

As shown by block 456, if the documents are identical, the agent 322 concludes that the in-focus window at the time of the underlying user activity was already (had previously been) opened, and the user activity of the user activity notification did not involve or result in a new document having been opened. In this case, the process proceeds to block 450 where the agent 322 resumes waiting and listening for a subsequent user activity to occur at the corresponding endpoint device 104a.

If the comparison (block 456) reveals that the document from the window that was in-focus at the time of the underlying user activity does not match the document that was in cache and for that window, then the agent 322 concludes that the document from the in-focus window at the time of the underlying user activity was a newly opened document (that did not exist in that window prior to the latest user activity) and the system 100 generates a new document open report that is made available at terminal to an IT security professional, or the like, (e.g., at terminal 107) as shown by block 458. In a typical implementation, the event may be sent to the cloud service and can be seen there as part of other information on the user session, to further analyze the user actions.

In a typical implementation, once the agent 322 determines a new document open report is warranted, the agent 322 sends a communication to the ITM application server 102 requesting that a new document open report be generated. The communication may include various data associated with the new document opening including any data/metadata that the system 100 may end up making available with the new document open report.

FIG. 5 is a screenshot from an exemplary ITM user interface (UI) 108 at device 107 that includes document open reports generated by system 100.

The left side of the illustrated UI 108 has a “Most Active Users” header, indicating the report relates to the most active users on the monitored system 100 filtered by document open events. The level of activity represented in the illustrated UI 108 may represent activity level across any one of a variety of different regions, times, sources, etc. Moreover, in a typical implementation, the ITM application (including the UI 108) may provide users such as IT security professionals, one or more user-manipulable filters to filter data collected for processing by the system 100 and/or for reports generated by the system 100 in various ways.

In the illustrated UI 108 (as indicated in the rectangular with arrowhead box at the top left of the screen), the data provided on the UI is for the most active users in a geographic region designated “US1,” over a time period of seven days (“7d”), at sources designated as “Endpoint/Ale . . . +1”). Moreover, in the illustrated UI 108 (as indicated in the pill-shaped field at the top of the page), the “category” in which the identified “most active users” are active is in “document open” activities. “EndpointAle . . . +1” is the endpoint/alerts category, meaning the displayed events indicate where the source is an endpoint or alert. It should be noted that the screenshot of FIG. 5 only displays a portion of the data available for display to the user, and hovering on top of various screen object will expand to show more data. The screen shot shown in FIG. 5 includes a histogram representing a distribution of document open activities over time according to specified applicable filter criteria, which may be determined according to a particular application.

As shown by FIG. 5, beneath the histogram in the illustrated UI 108, an “Activity Summary” identifies, in tabular form, user names for each respective one of a plurality of system “users” and a corresponding “activity count” for each respective user. Each user name corresponds to a particular one of a plurality of human system users. Each “activity count” identifies the number of times that the system 100 determined that the corresponding human user performed the filtered activity on the system 100. As shown, the filtered activity in the illustrated implementation is a “document open” activity that was performed in the US1 region, over the past seven days (7 d), at any of the indicated source(s) (i.e., Endpoint/Ale . . . +1). Even more specifically, the illustrated exemplary UI shows that the system 100 determined that user isofer performed the filtered activity 355 times, user administrator performed the filtered activity 21 times, user msantana performed the filtered activity 3 times, and user jseliam performed the filtered activity 1 time.

As indicated by the slightly different shading of the isofer line in the “Activity Summary” table, that table entry is expanded (to the right) to show additional information about specific instances of the filtered activities that the system 100 determined that user isofer had performed. In a typical implementation, the UI 108 is responsive to user selections (made, e.g., with a cursor/mouse or with arrows and enter button on a keyboard, etc.) of user lines in the “Activity Summary” listing and expands the available information for a selected user line (as shown for the isofer line in the illustrated example).

There are five specific instances represented in the “filtered activities” listing of the illustrated UI 108. In a typical implementation, the listing of “filtered activities” information may include additional information about all of the associated “filtered activities” for the corresponding user. Moreover, in a typical implementation, the “filtered activities” listing may be scrollable (e.g., by mouse or keyboard arrows, etc.) to enable a human user to view the additional information for all of the associated “filtered activities.” In a typical implementation, the illustrated example, where user isofer has an “activity count” of 355, the corresponding “filtered activities” listing for isofer would include additional information for every one of the 355 activities associated with user isofer.

The additional information about each isofer activity in the “filtered activities” listing on the illustrated UI 108 includes a date and time of the associated activity, an “activity” type (which, in the illustrated example, is always “document open”), “categories” (e.g., file open, application use, file tracking, etc.) applicable to the associated activity, the “user” who performed the associated activity (i.e., Itay Sofer in the illustrated example), and any “aliases” for that user. In the illustrated example, the email address (isofer@proofp . . . ) of the user is identified as the user's “alias.”

As indicated by the slightly different shading of the second entry in the listing of “filtered activities,” that listing entry is expanded (to the right) to show additional information “file activity details” about the file related to the associated document. The “file activity details” include a chronological listing of user activities that the system 100 captured related to the associated document and its file. Each entry in the “file activity details” portion of the UI 108 relates to a particular one of a sequence of user activities that the system 100 captured and determined to be involved with the document/file at issue. Moreover, each entry in the “file activity details” portion of the UI includes the activity itself (“document open,” “copy to USB,” “file rename,” “file copy,” “web file download”), a “user name” for the user who performed the associated activity, a path (e.g., “C\Demo”), an “application name (e.g., “Powerpoint”) and other information shown in the illustrated UI 108.

According to the illustrated listing of “file activity details” for document associated with the second to last “document open” activity in the “filtered activities” list, it can be seen that the system 100 captured a sequence of events in which user isofer downloaded the document, copied the file, renamed the file, copied the file to a USB device, then opened the document, then copied to USB, then opened the document.

In a typical implementation, information appearing on UI 108 that relates to a particular “document open” activity collectively amounts to a new document open report that may be generated by the system 100 (see FIG. 4, block 458). In a typical implementation, each agent 322 deployed on one of the endpoint devices 104a, 104b. 104n collects and transmits to the ITM application server 102 at least all the types of data that appears in the UI 108 for every document open event that happens at its corresponding endpoint device.

Referring again to the flowchart in FIG. 4, after the new document open event is reported (see block 458), as shown by block 460, the agent 322 clears the cache 213 associated with the in-focus window if any data is stored there. The cache 213 is cleared since the current windows no longer holds the old document (replaced by a new document), so a subsequent re-opening of the old document may be recognized. Thus, in a typical implementation, after step 460, the cache 213 has been emptied for the window that was in-focus at the time of the latest new user activity (see block 452). When the old document has been cleared, the cache contains the new document attached to the focus window.

As shown by block 462, the agent 322 stores new information about the document from the in-focus window at the time of the latest user activity (see block 452) in the cache 213. This new information may include, for example, a copy of the document itself as well as any other data or metadata associated with the document. Such metadata, for example, the full path and file name of the document, may be helpful for identifying the document. In a typical implementation, after block 462, the cache 213 contains data about the document from the in-focus window at the time of the latest user activity (block 452). Thus, the next time the agent 322 (block 456) compares a document from an in-focus window at one of the endpoint devices to the content of the cache 213, the cache 213 contains a copy of whatever document was last opened in that window. Typically, after step 462, the content stored in cache 213 remains intact until the process represented in the illustrated flowchart cycles back to blocks 460/462 for subsequent user activity.

As shown by block 464 the agent 322 considers whether the user that just opened the document in the window was authorized to do so. There are a variety of ways in which this step may be performed. For example, the system 100 may store a listing of user-specific file access restrictions for certain sensitive or confidential documents. Here, the system 100 (at 464) may compare information about the document (e.g., file name, file storage location, file sensitivity based on content, etc.) and information about the user (e.g., username, aliases, email address, etc.) against the listing of user-specific file access restrictions to determine if any of the listed restrictions indicate that the associated user should not be permitted to view the document.

As shown by block 466, if the system 100 has determined that the user is not authorized to view the document, then the system 100 automatically closes the document and/or creates an alert—either to the user, letting the user know that he or she is not authorized to view the document, or to an IT security professional, letting him or her know that the particular user has opened the document without authorization and is likely viewing it. The user and/or the IT security professional then has the option of taking further action as appropriate or desired.

What follows are partial descriptions of two exemplary implementations of processes based on the concepts set forth in the flowchart of FIG. 4. The first example represents an implementation for a system where the endpoint device at issue is running the macOS™ operating system and the second example represents an implementation for a system where the endpoint device at issue is running a Windows® operating system.

With macOS™ Operating System:

In this example, on every activity, the system checks for a document object within accessibility properties related to the window in focus. This is actually an attribute of the accessibility object for the window. See, for example, https://developer.apple.com/documentation/applicationservices/kaxdocumentattribute?language=objc, which identifies macro kAXDocumentAttribute, the URL of the open document represented by this accessibility object. This attribute represents the URL as a string object.

If the system determines that there is a document based on the accessibility object property of the window in focus, and this document does not appear in cache as already reported for the window, the system concludes that this is a new document opened in this window and the system generates a new document open activity report, accordingly. Moreover, the system may connect the new document open activity report to file tracking data if file tracking exist (if, for example, the file property attached to the window was download from some site and then updated) and puts document information into cache so that the system will not report a new document open activity for that document in that window again.

When the window is closed, the system 100 clears cache for that window, so if the window is opened again and the document is there again the system 100 will conclude that the user activity is a new document open activity and generates another report, as mentioned above.

The document open event reporting, in a typical implementation, includes information such as that represented in FIG. 5, described above.

### With Windows® Operating System:

In this example for the Windows® operating system, detecting document open activity is based on listening to two sources: the file IO read events of ETW (Event Tracing for Windows) and windows UI system events of object name change. Alternatively, this may instead be done using accessibility inspection. Event Tracing for Windows (ETW) is a kernel-level tracing facility that facilitates logging of kernels or application-defined events to a log file. An object name change event is raised when application main window title is changed. If a document is opened for viewing or editing, its file name is contained in application window title.

Open file monitor contains a data structure for storing all files and titles for each prioritized application. This data structure is a mapping between the process ID and a pair of hash sets: a first hash set for the traced file names and a second hash set for the file names in the application title. Once a file read operation is detected, the file name is added to the traced files hash set; once title change is detected, the file name in title is added to the titles hash set. If the system determines there is an intersection between the first and second hash sets, the intersection is the name of the file being opened for viewing or editing, and the system publishes a message, for example, a new document open activity report. This is one exemplary way to correlate open files by the app to real open documents based on window title updates.

In an exemplary implementation, handling a file IO read event may entail one or more of the following: 1) stopping if the source process is not one of a predetermined list of prioritized applications (for example, Word, Excel, Power Point, Adobe Acrobat Reader or Foxit Reader, among others), 2) stopping if the file extension is included in an ignored files list stored in memory (for example, “.tmp”, “.crdownload”, “.opdownload”, “partial”, “.part”, “.lnk”, “.temp”, “.exe”, “.dll”), 3) adding file name to the file read hash set of the source process, and/or 4) if the file name without a path or extension is included in the titles hash set, publishing an open file message, for example, generating a new document open activity report. Here, “stopping” refers to the system, for example the agent, closing the current window and optionally sending a pop-up notification to the user endpoint device indicating the user lacks the requisite authorization to view the closed document.

In an exemplary implementation, handling an object name change event may entail one or more of the following: 1) stopping if the source process is not one of the prioritized applications (starting with: Word, Excel, Power Point, Adobe Acrobat Reader or Foxit Reader), 2) extracting the file name from title and stopping if the title does not contain file name, 3) adding the file name to the titles hash set of the source process, and/or 4) if there is a traced file, which file name only equals to file name in title, publishing an open file message, for example, generating a new document open activity report.

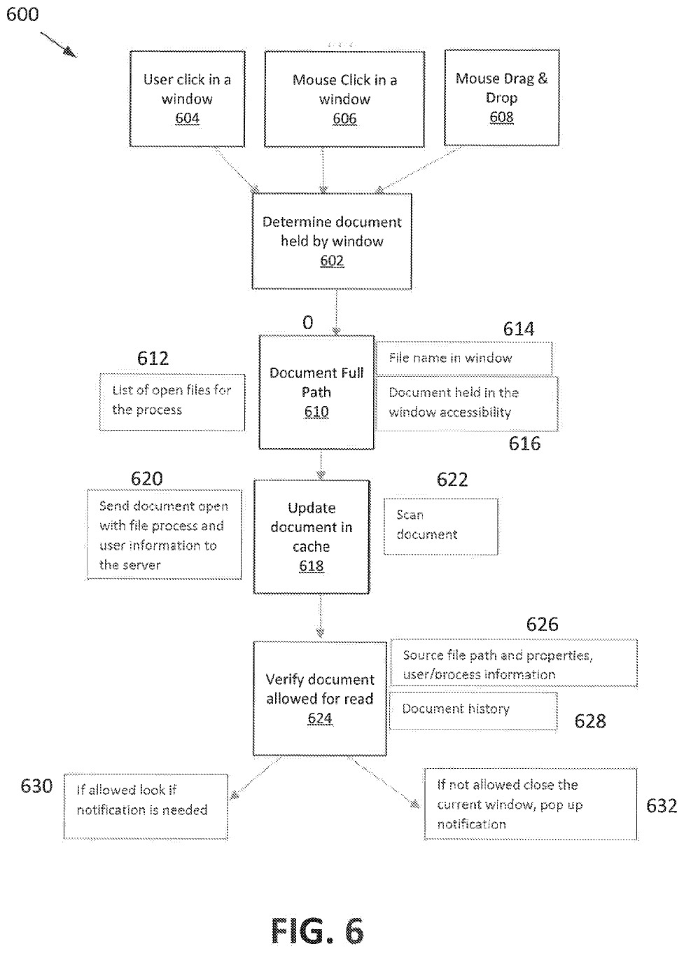

FIG. 6 shows a schematic block diagram 600 providing details of an implementation of the process of FIG. 4. The system 100 determines the document held by the in focus window, as shown by block 602, for example, in response to a user click into the window (block 604), a mouse click into the window (block 606), or a mouse drag-and-drop operation (block 608). As shown by block 610, the system 100 may consider the document full path with a list of open files for the process (block 612), and/or a file name in the window (block 614), and/or documents held in the window accessibility (block 616). The system 100 updates the document in the cache, as shown by block 618. The document open may be sent with file process and user information, for example, to the ITM server, as shown by block 620. A scan of the document may be provided into cache as well, as shown by block 622.

The system 100 verifies that the document is allowed to be read, as shown by block 624. The source file path, properties, and sensitivity level, as well as user/process information (block 626) may be relevant in this regard. A document history (block 628) may be relevant in this regard. If the system 100 determines that the user is allowed to look at the document, the system 100 considers whether a notification (e.g., to an IT security professional) is warranted, as shown by block 630. If the system 100 determines that the user is not allowed to look at the document, the system, for example the agent, closes the current window and may send a pop-up notification to the user's endpoint device informing the user that he or she lacks the requisite authorization to view the closed document, as shown by block 632.

While a number of embodiments of the invention have been described, it should be understood that various modifications may be made without departing from the spirit and scope of the invention.

For example, a new document open report can take on any one of a variety of different forms. In a typical implementation, however, the new document open report includes information representing the fact that the specific new document was opened. The report may identify information identifying the specific document at issue (including, for example, the file name or other identifier, sensitivity and content information), the window, the user who caused the document file to open, amongst other information, such as historical data about the associated document, window, user, and/or actions relating to same.

The new document open report may be delivered in the form of a notification within a computer software application that presents a user interface at the terminal 107. The report may be communicated in the form of an email, SMS, or any other convenient electronic form of transmitting data or notifications.

In various implementations, certain steps and/or system components may be modified or omitted. For example, in some implementations, FIG. 4 blocks 464 and/or 466 may be omitted.

Typically, each open window that contains an open file or document at an endpoint device 104a, 104b . . . 104n has an associated computer application (e.g., Microsoft® Word™, or Adobe Acrobat™), the file or document visible in the window, and is associated with a particular user session on the endpoint device 104a, 104b . . . 104n. In a typical implementation, some or all of this information may be visibly identified in (e.g., the title bar of) the window. The window itself may identify the computer application (e.g., Microsoft® Word™, or Adobe Acrobat™) associated with the window, a file name (e.g., “Draft Patent Application”) for the file or document visible in that window, and/or a name of the human user (e.g., “John Doe”) whose user session is in progress on the endpoint device 104a, 104b . . . 104c, among others.

The behavior of focus in the endpoint computers may be governed by one or more window management policies stored, for example, in computer memory. Some exemplary focus behaviors policies are click-to-focus, and focus follows pointer. Focus may change in accordance with one or more of these, or some other policy.

Click to focus is a common focus behavior policy in which a human user must click the mouse inside of the window for that window to gain-focus. This also typically results in that window being raised above all other windows on screen. With a click to focus policy, a current in-focus application window continues to retain-focus and collect input, even if the mouse pointer is over another application window on the display. In a computer that utilizes a focus follows pointer (or focus follows mouse (“FFM”)) policy, the focus automatically follows the current placement of the pointer. The focused window is not necessarily raised; parts of it may remain below other windows. Window managers with this policy usually offer an auto raise option, which raises the window when it is focused, typically after a configurable short delay. A possible consequence of this sort of policy is that no window has focus when the pointer is moved over the background with no window underneath; otherwise focus may simply remain with the last in-focus window. Other focus behaviors policies are possible.

It should be understood that the example embodiments described herein may be implemented in many different ways. In some instances, the various methods and machines described herein may each be implemented by a physical, virtual, or hybrid general purpose computer, such as a computer system, or a computer network environment, such as those described herein. The computer/system may be transformed into the machines that execute the methods described herein, for example, by loading software instructions into either memory or non-volatile storage for execution by the CPU. One of ordinary skill in the art should understand that the computer/system and its various components may be configured to carry out any embodiments or combination of embodiments of the present invention described herein. Further, the system may implement the various embodiments described herein utilizing any combination of hardware, software, and firmware modules operatively coupled, internally, or externally, to or incorporated into the computer/system.

Various aspects of the subject matter disclosed herein can be implemented in digital electronic circuitry, or in computer-based software, firmware, or hardware, including the structures disclosed in this specification and/or their structural equivalents, and/or in combinations thereof. In some embodiments, the subject matter disclosed herein can be implemented in one or more computer programs, that is, one or more modules of computer program instructions, encoded on computer storage medium for execution by, or to control the operation of, one or more data processing apparatuses (e.g., processors). Alternatively, or additionally, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or can be included within, a computer-readable storage device, a computer-readable storage substrate, a random or serial access memory array or device, or a combination thereof. While a computer storage medium should not be considered to be solely a propagated signal, a computer storage medium may be a source or destination of computer program instructions encoded in an artificially generated propagated signal. The computer storage medium can also be, or be included in, one or more separate physical components or media, for example, multiple CDs, computer disks, and/or other storage devices.

Certain operations described in this specification can be implemented as operations performed by a data processing apparatus (e.g., a processor/specially programmed processor/computer) on data stored on one or more computer-readable storage devices or received from other sources, such as the computer system and/or network environment described herein. The term “processor” (or the like) encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations may be described herein as occurring in a particular order or manner, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

There may be other possible solutions to detect and prevent document open events, some of which work with low level file open methods where they detect and prevent file openings, however these tend to be error prone as an app may open files that are not really documents and the user did not ask them to be opened for its regular operation. Moreover, while working on a file, the app may open it multiple times while the user has actually opened the document just once, so it does not really tell the story as to how many times a user really opened a document, as well as for prevention if you want to scan the file it is not easy to hold off a file open event for a long time and can create issues on the OS level, our solution works on the UI level, so it can detect when a user really opened a document using the UI, and at this point can scan the document for detection or prevention.

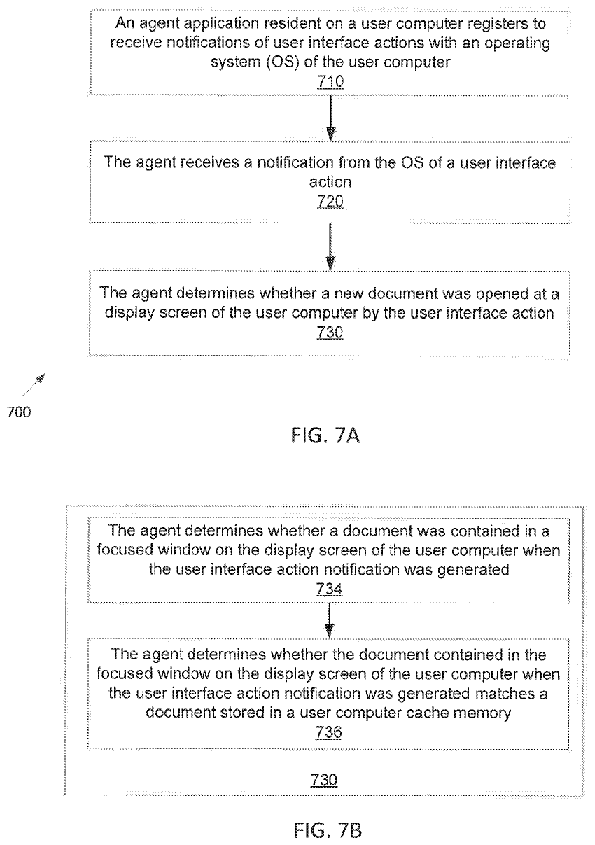

FIG. 7A is a flowchart of an exemplary method embodiment for an agent application hosted by a user computer of a computer system for detecting whether a new document has been opened via a user application accessible by a human user at the user computer. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

The agent application registers to receive notifications of user interface actions with an operating system (OS) of the user computer, as shown by block 710. The agent receives a notification from the OS of a user interface action, as shown by block 720. The agent determines whether a new document was opened at a display screen of the user computer by the user interface action, as shown by block 730.

FIG. 7B is block diagram detailing determining whether a new document was opened at a display screen, as per block 730. The agent determines whether a document was contained in a focused window on the display screen of the user computer when the user interface action notification was generated, as shown by block 734. The agent determines whether the document contained in the focused window on the display screen of the user computer when the user interface action notification was generated matches a document stored in a user computer cache memory, as shown by block 736.

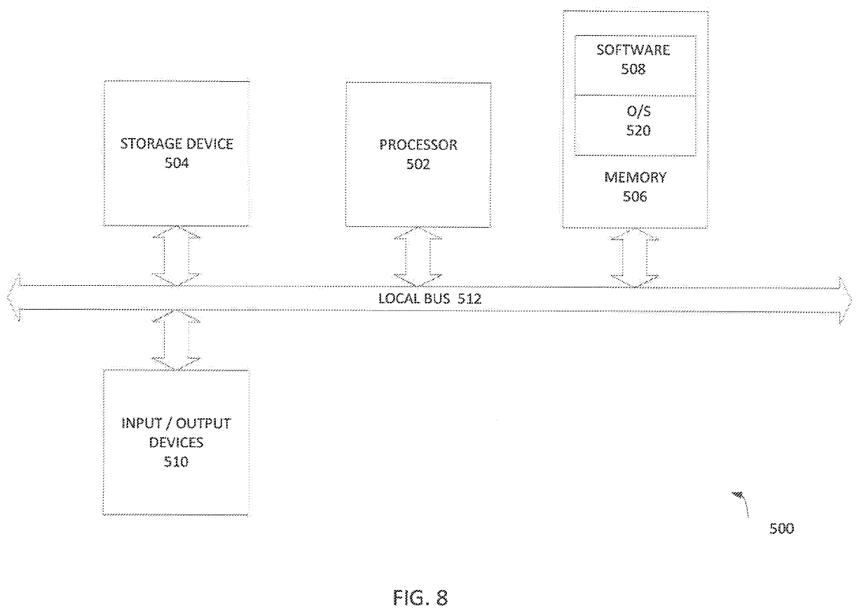

As previously mentioned, the present system for executing the functionality described in detail above may be a computer, an example of which is shown in the schematic diagram of FIG. 8. The system 500 contains a processor 502, a storage device 504, a memory 506 having software 508 stored therein that defines the abovementioned functionality, input, and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Compared to previous systems, the present embodiments may indicate when a user has both opened and viewed the document. This is in contrast to detection of a general file open, which may occur in instances when a process opens a document but the user may not have actually viewed the document.

It will be apparent to those skilled in the art that various modifications and variations can be made to the structure of the present invention without departing from the scope of the invention. In view of the foregoing, it is intended that the present invention cover modifications and variations of this invention provided they fall within the scope of the following claims and their equivalents.

What is claimed is:

1. A computer system for detecting whether a new document has been opened at a user computer on the computer system, the computer system comprising:
the user computer comprising a processor and memory;
a user application accessible by a human user at the user computer; and
an agent application hosted by the user computer and configured to:
register to receive notifications of user interface actions with an operating system (OS) of the user computer;
receive a notification from the OS of a user interface action; and
determine whether a new document was opened at a display screen of the user computer by the user interface action.

2. The computer system of claim 1, wherein determining whether a new document was opened at the display screen of the user computer by the user interface action further comprises:
determining, with the agent, whether a document was contained in a focused window on the display screen of the user computer when the user interface action notification was generated.

3. The computer system of claim 2, further comprising a cache memory,
wherein determining whether a new document was opened at the display screen of the user computer by the user interface action further comprises:
determining, with the agent, whether the document contained in the focused window on the display screen of the user computer when the user interface action notification was generated matches a document stored in the cache memory.

4. The computer system of claim 3, further comprising:
an admin computer configured to present a user interface at a display screen of the admin computer to reports on user activities that cause or result in new documents being opened at the user computer.

5. The computer system of claim 4, wherein the agent is further configured to cause the system to generate a report at the user interface of the admin computer in response to the agent determining that the document contained in the focused window on the display screen of the user computer when the user interface action notification was generated does not match the document stored in the cache memory.

6. The computer system of claim 4, wherein the system clears the cache memory for the in focus window if the agent determines that the document contained in the focused window on the display screen of the user computer when the user interface action notification was generated does not match the document stored in cache memory.

7. The computer system of claim 6, wherein the system stores the document from the in-focus window and/or related data in the cache memory after clearing the previous in-focus window from the cache memory.

8. The computer system of claim 7, wherein the system determines whether the user performing the user activity resulting in the new document being opened at the user computer has permission to view the document.

9. The computer system of claim 8, wherein the system automatically closes the new document at the user computer and notifies an administrator and optionally the user in response to determining that the user lacked permission to view the document.

10. The computer system of claim 3, wherein the agent reverts to listening for a subsequent notification from the OS of a subsequent user interface action if the agent determines that the document contained in the focused window on the display screen of the user computer when the user interface action notification was generated matches the document stored in cache memory.

11. The computer system of claim 5, wherein the system connects the report on the new document open activity to file tracking data based upon whether file tracking exists.

12. The computer system of claim 11, wherein the report is correlated with another event on the user session.

13. A method for an agent application hosted by a user computer of a computer system for detecting whether a new document has been opened via a user application accessible by a human user at the user computer at the user computer, comprising the steps of:
registering to receive notifications of user interface actions with an operating system (OS) of the user computer;
receiving a notification from the OS of a user interface action; and
determining whether a new document was opened at a display screen of the user computer by the user interface action.

14. The method of claim 13, wherein determining whether a new document was opened at the display screen of the user computer by the user interface action further comprises the step of:
determining whether a document was contained in a focused window on the display screen of the user computer when the user interface action notification was generated.

15. The method of claim 14, wherein the user computer further comprises a cache memory, and determining whether a new document was opened at the display screen of the user computer by the user interface action further comprises the steps of:
determining, whether the document contained in the focused window on the display screen of the user computer when the user interface action notification was generated matches a document stored in the cache memory.

16. The method of claim 15, further comprising the step of:
causing the system to generate a report at the user interface of an admin computer of the computer system in response to the agent determining the document contained in the focused window on the display screen of the user computer when the user interface action notification was generated does not match the document stored in the cache memory,
wherein the admin computer is configured to present a user interface at a display screen of the admin computer to report on user activities that cause or result in new documents being opened at the user computer.

17. The method of claim 15, further comprising the step of:
reverting to listening for a subsequent notification from the OS of a subsequent user interface action if the agent determines that the document contained in the focused window on the display screen of the user computer when the user interface action notification was generated matches the document stored in cache memory.

18. The method of claim 16, further comprising the step of clearing the cache memory for the in focus window if the agent determines that the document contained in the focused window on the display screen of the user computer when the user interface action notification was generated does not match the document stored in cache memory.

19. The method of claim 18, further comprising the step of storing the document from the in-focus window and/or related data in the cache memory after clearing the previous in-focus window from the cache memory.

20. The method of claim 19, further comprising the step of determining whether the user performing the user activity resulting in the new document being opened at the user computer has permission to view the document.

21. The method of claim 20, further comprising the step of closing the new document at the user computer and notifying an administrator in response to determining the user lacked permission to view the document.

22. The method of claim 16, wherein the system connects the report on the new document open activity to file tracking data based upon whether file tracking exists.

23. The method of claim 22, wherein the report is correlated with another event on the user session.
